(19) United States
(12) Patent Application Publication
(10) Pub. No.: US 2009/0083103 A1
(43) Pub. Date: Mar. 26, 2009

(54) METHOD AND SYSTEM FOR MEASURING ORGANISATIONAL CULTURE

(75) Inventor: Ian Basser, Victoria (AU)

Correspondence Address: Muncy, Geissler, Olds & Lowe, PLLC, P.O. BOX 1364, FAIRFAX, VA, 22038-1364, US

(73) Assignee: METTLE GROUP PTY LTD, North Sydney, NSW (AU)

(21) Appl. No.: 12/160,283

(22) PCT Filed: Jan. 9, 2007
(86) PCT No.: PCT/AU2007/000007

§ 371 Date: Nov. 24, 2008

(30) Foreign Application Priority Data
Jan. 9, 2006 (AU) 2006900088

(51) Int. Cl. G06Q 10/00

(52) U.S. Cl. 705/7

(57) ABSTRACT

A method for measuring the culture of an organisation includes establishing (202) a plurality of categories relating to the culture of the organisation, said categories being grouped into a plurality of clusters, wherein each cluster includes a selected one or more of the categories which relate to a predetermined aspect of organisational culture. Information is provided (206) by a plurality of individuals associated with the organisation, regarding each of said individual's personal experience of the culture of the organisation in relation to each of the categories. The received information is processed (208) to determine, with regard to each category, a corresponding category grade representing an extent to which the experience of the individuals is either positive or negative. A chart is generated (210) which includes graphical representations of each one of the clusters, each cluster graphical representation including graphical representations of the category grades determined for the categories grouped within the corresponding cluster. The method enables feedback to be obtained regarding the organisational culture from a variety of different individuals associated with the organisation, and the grouping of cultural categories into clusters facilitates a more effective appreciation of the contribution made by those aspects to the overall culture of the organisation. The chart may enable rapid visual assimilation of the overall culture of the organisation, with each cluster representing a specific and carefully chosen aspect of organisation culture. The method is preferably implemented as an online system, wherein information may be gathered from individuals, and results presented, via a convenient web-based interface.

### FIELD OF THE INVENTION

The present invention relates to the management of organisations, and more particularly to managing organisational culture.

### BACKGROUND OF THE INVENTION

There is an increasing awareness within organisations, such as corporations, businesses, and public and private sector institutes and departments, that the culture of an organisation strongly influences productivity and the success of the organisation in achieving organisational goals.

The culture of an organisation comprises the values and beliefs of the people in the organisation, individually as well as within groups or teams and the organisation as a whole. The organisational culture manifests itself in the unwritten rules and expectations of behaviour in an organisation, whereby individuals develop an understanding of what is expected of them, in addition to, and outside of, any formal written rules. In most organisations, organisational culture results from policy and management decisions made by the organisation's leaders. Ideally, the organisational culture embodies values and beliefs that support the organisational goals.

A positive and supportive organisational culture can help to motivate individuals, such as employees, within an organisation, and/or prevent them from becoming dissatisfied with the organisation. An organisational culture that does not satisfy the needs of individuals within the organisation may lead to dissatisfaction, and a disinclination by individuals to work willingly towards achieving organisational goals.

Accordingly, an organisation's culture needs to be managed in order to maintain a positive and supportive environment within the organisation, which also supports the achievement of organisational goals.

Methods, systems and tools have therefore been developed to assist managers of organisations in measuring organisational culture, and identifying needs and opportunities for organisational change in order to improve culture, and thereby increase productivity and the motivation of individuals within the organisation to work towards organisational goals. However, known tools for measuring organisational culture suffer from a number of limitations. For example, most such tools are based on surveys that are inflexible, in that they assume only one correct approach to organisational culture. That is, such tools may assume that a particular set of cultural qualities are desirable, and measure only the actual culture of an organisation against these predetermined qualities. This approach fails to take into account the fact that different organisations, having different organisational goals, may value certain qualities or aspects of organisational culture more highly than others, and have different priorities in terms of those qualities than may exist in another organisation, having different organisational goals.

Furthermore, existing tools do not generally enable feedback to be obtained, regarding organisational culture, on an individual, team or organisational basis, from a number of different sources, including individuals and groups at various levels within the organisation, as well as from clients or other stakeholders such tools are generally also unable to produce integrated results while avoiding the aforementioned trap of being a “one solution fits all” system.

It is therefore desirable to provide an improved method and system for measuring organisational culture that mitigates one or more of the aforementioned limitations. It is also desirable to provide such a method and system that is easily deployed within an organisation, and which may be automated to achieve rapid feedback regarding organisational culture.

### SUMMARY OF THE INVENTION

In one aspect the present invention provides a method for measuring the culture of an organisation, including the steps of:

establishing a plurality of categories relating to the culture of the organisation, said categories being grouped into a plurality of clusters, wherein each cluster includes a selected one or more of said categories relating to a predetermined aspect of organisational culture;

receiving information provided by a plurality of individuals associated with the organisation regarding each of said individual's personal experience of the culture of the organisation in relation to each of said categories;

processing said received information to determine, with regard to each category, a corresponding category grade representing an extent to which the experience of said individuals is either positive or negative; and

generating a chart which includes graphical representations of each one of said clusters, each said cluster graphical representation including graphical representations of the category grades determined for the categories grouped within the corresponding cluster.

Accordingly, a method in accordance with the present invention enables feedback to be obtained regarding the organisational culture from a variety of different individuals associated with an organisation, including members of the organisation, such as employees, managers and so forth, as well as other associated individuals and stakeholders, such as clients of the organisation. It is thereby possible to provide 360° feedback on organisational culture from an individual, team and organisational perspective, as well as obtaining such feedback from eg customers or clients.

Furthermore the grouping of cultural categories (which may be, for example, particular desirable cultural qualities) into clusters relating to particular aspects of organisational culture facilitates a more effective appreciation of the contribution made by these aspects to the overall culture of the organisation, and an understanding of the meaning of results generated by the method. In particular, this approach may assist in enabling an organisation to identify those qualities and aspects of organisational culture that are of greatest significance in achieving the organisation's particular goals, enabling a flexible approach to the measurement and change of organisational culture that enables the specific needs of the organisation to be taken into account, thereby avoiding a “one solution fits all” approach.

In particularly preferred embodiments the method of the invention is computer implemented, and at least the steps of processing received information and generating a chart are carried out using a computer, to provide rapid and effective results to the organisation.

In order for the method to be adapted to specific organisational needs, the method preferably also includes the step of defining a desired target culture in the form of a set of target category grades, and including in the generated chart graphical representations of the target category grades in conjunction with the determined category grades resulting from processing of the received information. This approach provides the particular advantage that it is possible to see at a glance the difference between a measured organisational culture and a desired target organisational culture, thereby further ensuring that the method is not limited to a “one solution” approach, in which the target culture is fixed and cannot be adapted in accordance with the goals and desires of the organisation and/or its leaders.

The target category grades may be defined by leaders or managers of the organisation ranking the categories in accordance with their perceived importance to the overall strategy of the organisation. For example, more highly ranked categories may then be assigned higher target grades. A particularly preferred ranking system, involving the classification of categories into three levels of importance, is described hereafter with reference to the accompanying drawings.

In a particularly preferred embodiment described herein, 21 categories are provided, which are grouped into six clusters, the full details of which are also described hereafter with reference to the accompanying drawings. The particular categories and clusters described herein have been developed through many years of experience in assessing the development of individuals and organisations, and dealing with human psychology. However, it will be appreciated that additional or alternative categories and/or clusters may be developed, and accordingly the described categories and clusters, while considered to be especially advantageous, should not be considered to be limiting.

As previously mentioned, each category may represent a particular quality which may be expressed within the organisational culture.

In a preferred embodiment, a “core” cluster includes six categories or qualities, and five further clusters each include three categories or qualities, to make up the 21 categories grouped into six clusters.

Advantageously, the grouping of categories into clusters in a graphical form in the generated chart may enable rapid visual assimilation of the overall culture of the organisation, with each cluster representing a specific and carefully chosen aspect of organisational culture. According to a preferred embodiment each such aspect is an identifiable, and predetermined, organisational culture type, and it has been found that most, common cultural aspirations of organisations conform to one of these predetermined types.

The step of receiving information preferably includes receiving responses to a questionnaire, and in a particularly preferred embodiment the responses are input to a computer system for processing. The questionnaire preferably includes a number of questions in relation to each category. The questions may include questions relating to positive aspects of organisational culture and/or questions relating to negative aspects of organisational culture. In the particularly preferred embodiment described herein, there are six questions in total associated with each category, three of which relate to positive aspects of culture, and three to negative aspects of culture.

In a preferred embodiment, questions are provided in the form of statements, and individuals respond by indicating the extent to which they agree or disagree with the statements. Responses may be provided on a scale, for example a scale of 1 to 6, corresponding with “strongly disagree”, to “strongly agree”. It will therefore be appreciated that a low score with respect to a negative question, or a high score with respect to a positive question, may indicate that a strong, positive, performance-enhancing culture has been established with respect to the corresponding quality or category. Conversely, a low score with respect to a positive question, or a high score with respect to a negative question, may indicate that a negative, performance-limiting culture exists, such that change is crucial.

In processing the received information, the resulting category grades may be numerical scores. For example, each category grade may represent a percentage of individuals who respond positively to questions relating to the corresponding category. In particular, the category grades may be the percentage of individuals who respond by assigning a high score to positive statements and/or a low score to negative statements associated with the categories. In one embodiment, a positive response is indicated where a respondent assigns a score of 5 or 6 on a scale of 1 to 6, to positive statements and/or a score of 1 or 2 to negative statements.

In generating the chart, clusters may be represented as circles, and corresponding categories as segments or “wedges” within each circle, wherein each segment is coloured, shaded, or otherwise marked to represent the corresponding category grade. Where the grade is a numerical score, as is preferred, each segment is marked at a radial distance between the centre and the circumference of the corresponding cluster circle, in accordance with the numerical score. For example, each segment may be coloured or shaded between the centre and said radial distance.

The method may be used to measure the culture of an organisation as experienced in relation to the behavioural performance of each individual, in relation to a team or teams within the organisation, or in relation to the organisation as a whole. In order to achieve these different perspectives, individuals may be asked to respond to questions or statements by considering how they apply to themselves as individuals, to their team or another team, or to the organisation as a whole. As will be appreciated, minor grammatical variations to the questions or statements may be made as appropriate in each of these contexts.

In another aspect, the present invention provides a system for measuring the culture of an organisation, the system including:

an input peripheral interface;

an output peripheral interface;

at least one storage medium containing information relating to a plurality of categories relating to organisational culture, the categories being linked within the storage medium so as to form logically a plurality of clusters wherein each cluster includes a selected one or more of said categories relating to a corresponding predetermined aspect of organisational culture; and

at least one central processing unit coupled to the at least one storage medium, the input peripheral interface and the output peripheral interface,

wherein said at least one storage medium further includes program instructions for execution by the central processing unit, said program instructions causing the central processing unit to execute the steps of:
receiving via the input peripheral interface information provided by a plurality of individuals associated with the organisation regarding each of said individual's personal experience of the culture of the organisation in relation to each of said categories, and storing said information within the at least one storage medium;
processing said information to determine, with regard to each category, a corresponding category grade representing an extent to which the experience of said individuals is either positive or negative;
generating a chart which includes graphical representations of each one of said clusters, each said cluster graphical representation including graphical representations of the category grades determined for the categories grouped within the corresponding cluster; and
communicating via the output peripheral interface said chart to at least one user of the system.

The at least one storage medium may include volatile storage, or memory, such as conventional solid-state semiconductor memory devices. Additionally or alternatively the at least one storage medium may include non-volatile solid-state memory, such as read-only memory or flash-memory devices. The at least one storage medium may further include magnetic and/or optical storage devices, such as hard-disk drive units, and/or optical-disk drive units, such as CD-ROM or DVD-ROM units.

The input peripheral interface may include standard user input devices, such as a keyboard, a mouse or other pointing device, and/or alternative input devices such as voice-recognition systems. The output peripheral interface may include a display device, such as a visual display unit, and/or hard copy devices such as printers and the like. In particularly preferred embodiments, the system is implemented as a networked server, available for remote access by users, and most preferably is a web-based server. Accordingly, the input and output peripheral interfaces most preferably include network interface devices, providing wired and/or wireless access to the server, whereby users are able to interact with the system via remote terminals, such as standard personal computers executing conventional web-browser software applications.

In another aspect, the present invention provides a system for measuring the culture of an organisation, wherein a plurality of categories relating to the culture of the organisation is established, the categories being grouped into a plurality of clusters wherein each cluster includes a selected one or more of said categories relating to a corresponding predetermined aspect of organisational culture, the system including:

input means for receiving information provided by a plurality of individuals associated with the organisation regarding each said individual's personal experience of the culture of the organisation in relation to each of said categories;

a processor for processing said received information to determine, with regard to each category, a corresponding category grade representing an extent to which the experience of said individuals is either positive or negative; and

output means for generating a chart which includes graphical representations of each one of said clusters, each said cluster graphical representation including graphical representations of the category grades determined for the categories grouped within the corresponding cluster.

In a preferred embodiment of the invention, the system includes a computer, such as a web server. The input means accordingly may include one or more software components executing on at least one central processing unit of the computer the software components including executable instructions to effect reception of the information provided by said plurality of individuals. The input means may further include computer input peripherals, such as a keyboard and/or mouse to enable said individuals to enter the relevant information. Alternatively, or additionally, the input means may include suitable interface hardware for interfacing to a communications network to enable the information to be received from said individuals over the network. For example, in embodiments in which the system includes a web server computer, individuals may provide the information using a standard Internet web browser to complete questionnaire forms served by the web server and subsequently submitted using the web browser back to the server.

Preferably, the processor includes one or more software components executing on at least one central processing unit of a computer to process the received information to determine, with regard to each category, a corresponding category grade representing an extent to which the experience of the individuals is either positive or negative.

The output means may include a computer display connected to the computer system for displaying the generated chart or charts. Alternatively, where the system includes a web server computer, the output means preferably includes suitable interface hardware for interfacing to a data communications network for serving graphical information, such as web pages, to remotely located computers over the network, whereby the generated chart or charts are displayed on the remotely located computers using, for example, standard web browsing software.

In yet another aspect, the present invention provides a computer program product including computer executable instruction code for measuring the culture of an organisation, wherein a plurality of categories relating to the culture of the organisation is established, said categories being grouped into a plurality of clusters, wherein each cluster includes a selected one or more of said categories relating to a corresponding predetermined aspect of organisational culture, the computer program product including computer executable instruction code for effecting the steps of:

receiving information provided by a plurality of individuals associated with the organisation regarding each said individual's personal experience of the culture of the organisation in relation to each of said category;

processing said received information to determine, with regard to each category, a corresponding category grade representing an extent to which the experience of said individuals is either positive or negative; and

generating a chart which includes graphical representations of each one of said clusters, each said cluster graphical representation including graphical representations of the category grades determined for the categories grouped within the corresponding cluster.

Further preferred features and advantages of the present invention will be apparent to those skilled in the art from the following description of a preferred embodiment of the invention, which should not be considered to be limiting of the scope of the invention as defined in any of the preceding statements, or in any claims appended hereto.

### BRIEF DESCRIPTION OF THE DRAWINGS

A preferred embodiment of the invention is described with reference to the accompanying drawings in which:

FIG. 1 is a schematic diagram of a system for measuring organisational culture in accordance with a preferred embodiment of the invention;

FIG. 2 is a flowchart illustrating steps in a method for measuring organisational culture according to a preferred embodiment of the invention;

FIGS. 3 to 23 are examples of sets of questions corresponding with predetermined cultural qualities according to a preferred embodiment of the invention;

FIG. 24 is a chart including a target culture gauge generated in accordance with a preferred embodiment of the invention;

FIGS. 25 to 27 are screen shots illustrating a web-based questionnaire in accordance with a preferred embodiment of the invention;

FIG. 28 is a screen shot illustrating an interface for a user extracting a results spreadsheet according to a preferred embodiment of the invention;

FIG. 29 illustrates a results spreadsheet extracted using the interface illustrated in FIG. 28;

FIG. 30 illustrates bar charts of processed questionnaire results according to a preferred embodiment of the invention;

FIG. 31 shows a culture gauge including target and actual results generated in accordance with a preferred embodiment of the invention; and

FIG. 32 illustrates an administrative interface providing a page and processes index according to a preferred embodiment of the invention.

### DETAILED DESCRIPTION OF A PREFERRED EMBODIMENT

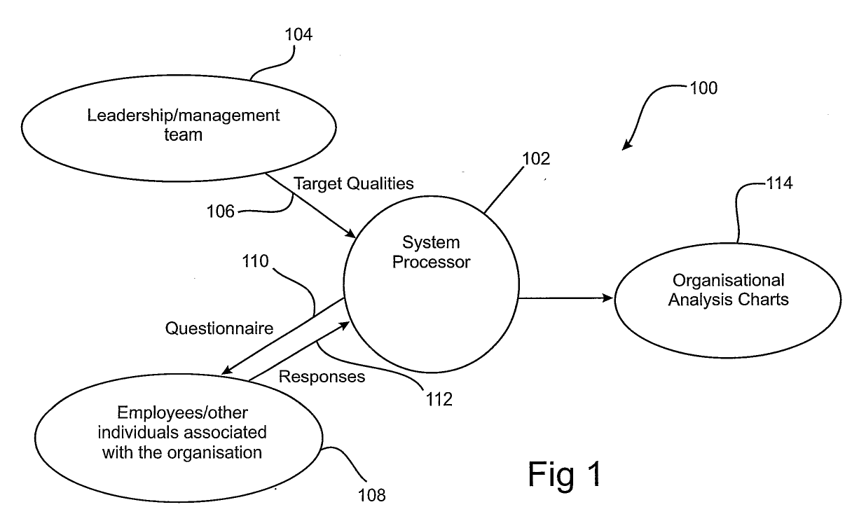

According to a preferred embodiment of the present invention, an automated procedure is provided to facilitate the measurement and analysis of organisational culture. A schematic diagram of an exemplary system 100 is illustrated in FIG. 1. The system 100 includes a system processor 102, which in the preferred embodiment is a computer or computer system including one or more central processing units upon which computer executable instruction code is run to effect the necessary process steps for implementing the preferred method and system for measurement and analysis of organisational culture.

The computer system used in implementing system processor 102 may be a stand-alone computer having various input and output peripherals for entering information and providing output data and charts in the form of visual displays and/or hard copies. In such embodiments, it will be appreciated that preferred input peripheral interfaces include common user input devices such as a keyboard, a mouse or other pointing device, and may alternatively or additionally include other input means, such as voice-recognition systems. Suitable output peripheral interfaces include conventional displays, such as visual display units, as well as hardcopy devices such as printers and the like.

However, according to a particularly preferred embodiment the system processor 102 includes web server functionality enabling the system to be operated by providing input and receiving output using remote computers with conventional web browser software for accessing the system processor 102 via an intermediate data communications network such as the Internet. As will be appreciated, in such preferred online embodiments the system processor 102 will conventionally incorporate input and output peripheral interfaces including suitable network interface devices for connection to the Internet and/or a local area network via wired or wireless connections. Suitable network interface technologies and devices will be readily apparent to those skilled in the relevant art.

According to a conventional computer system architecture, the system processor 102 also includes at least one storage medium, such as volatile memory (eg random-access memory), non-volatile memory (eg read-only memory or flash-memory) and/or persistent storage devices such as magnetic or optical disk drives (eg hard-disk drives, CD-ROM drives and/or DVD-ROM drives). The central processing unit, or units, are conventionally coupled to the relevant input and output peripheral interfaces, as well as to the various available storage media. The storage media are used to store and execute the program instructions controlling the operation of the computer system, as well as the data required by the programs, and for the temporary, short-term and/or long-term storage of intermediate and final results of the various processing operations carried out by the system processor 102. Preferred embodiments of the invention encompass, without limitation, known computer systems including the foregoing components, and/or their equivalents, suitable for the implementation and automation of various embodiments of the inventive method.

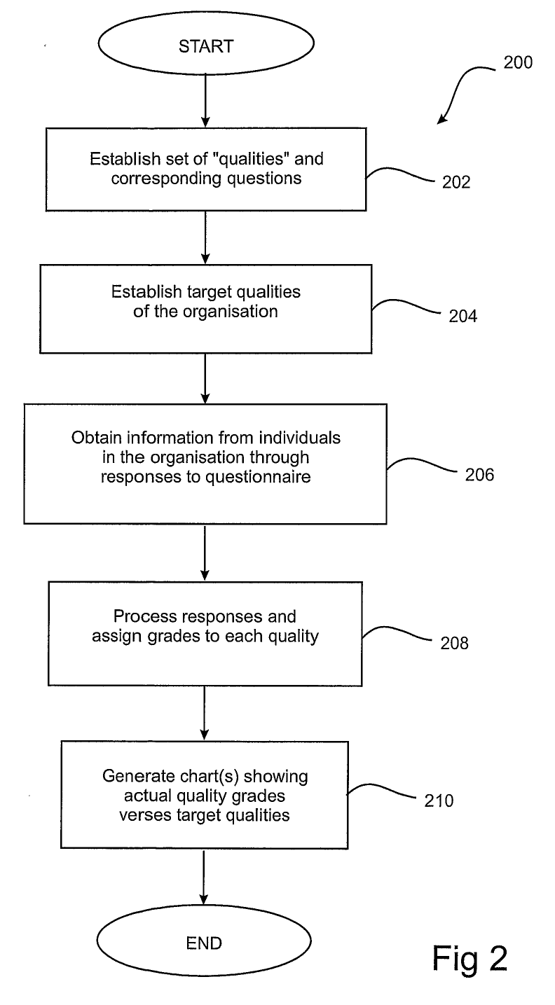

The operation of system 100 illustrated in FIG. 1 may be understood by reference to the exemplary flowchart 200 shown in FIG. 2. The flowchart 200 illustrates the main steps involved in the operation of the system 100 for measuring organisational culture in accordance with the preferred embodiment of the invention. The operation of the exemplary system 100 is therefore described in greater detail below with reference to both FIG. 1 and FIG. 2.

A key feature of the present invention is the establishment of a plurality of categories which relate to the culture of an organisation. The categories represent particular cultural qualities which may be important to the culture of an organisation, and accordingly these categories are also referred to herein as “qualities”. Significantly, the qualities are grouped into clusters, where a cluster represents a particular type of corporate culture. Extensive research and experience has been drawn upon by the present inventors, resulting in a statistically valid method for measuring the degree to which five particular types of identified corporate culture exist in people, teams and organisations. Specifically, it has been found that most cultural aspirations of organisations fit into one of these five specific types. The five predetermined clusters, or culture types, employed by the preferred embodiment of the invention are known as “External Care”, “Achievement”, “Innovative”, “One Team”, and “People First”. The particular attributes associated with these culture types are discussed in greater detail later in this specification.

A further, sixth, cluster of qualities make up the “core” qualities that, in accordance with the preferred embodiment, are considered to be essential to all organisational cultures. Again, the particular attributes of the core qualities are discussed in greater detail later in this specification.

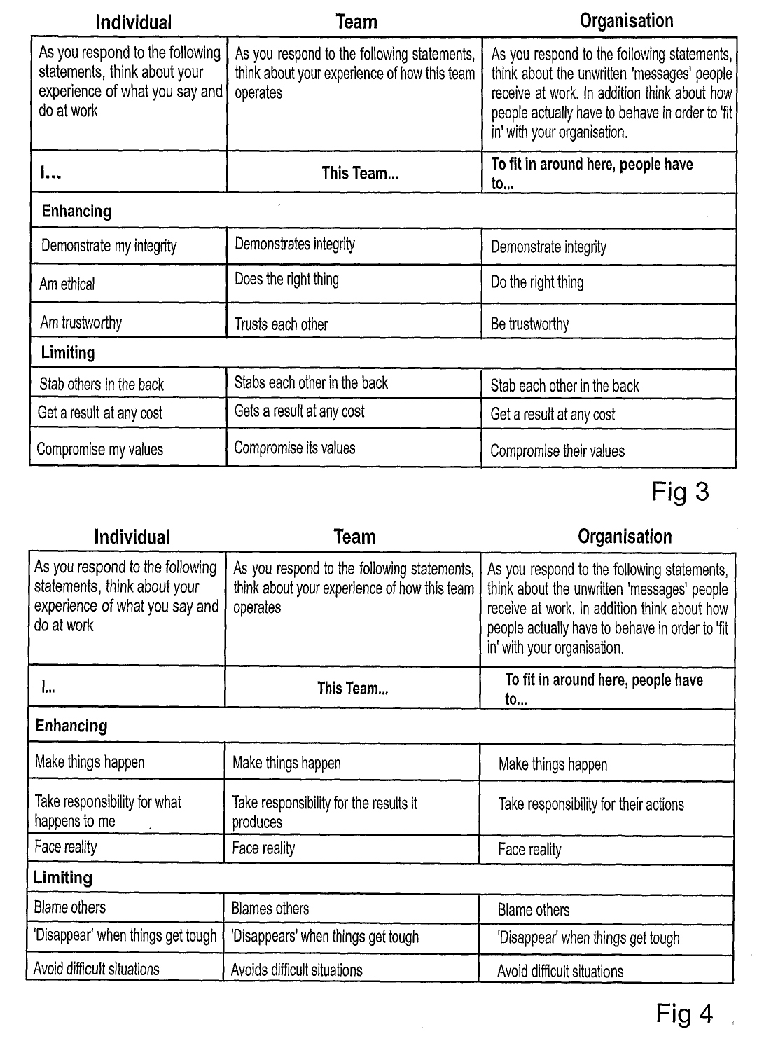

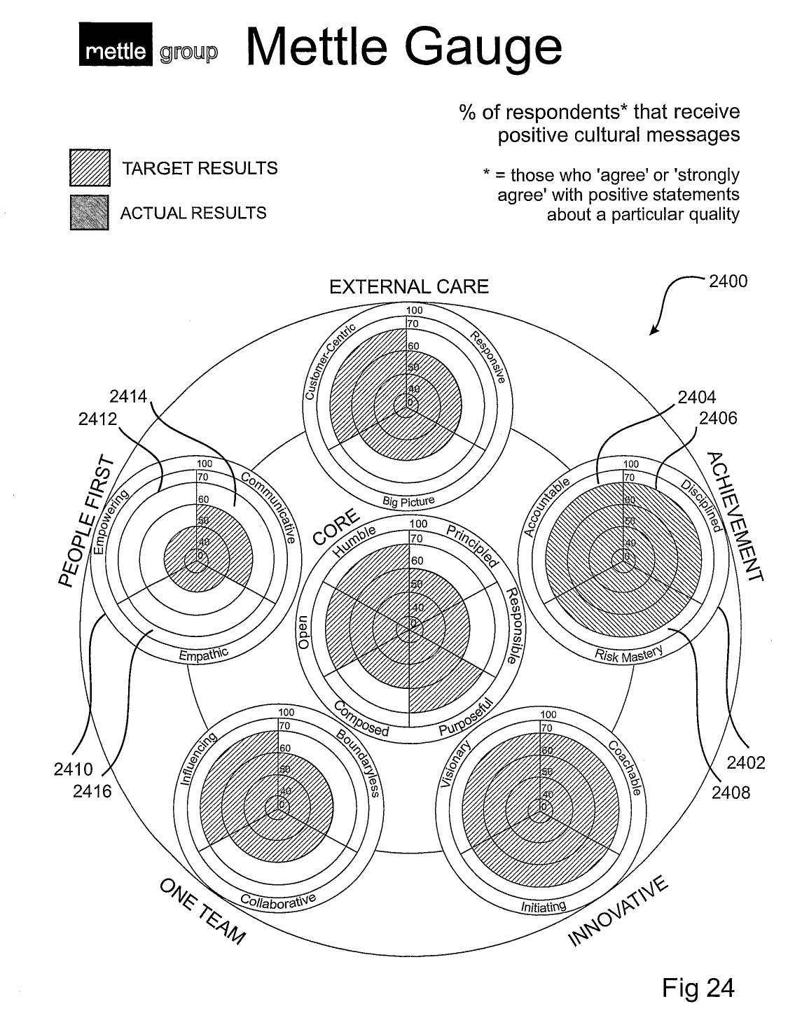

With the foregoing general discussion in view, the exemplary system 100 and method represented by flowchart 200 are now discussed with particular reference to FIGS. 1 and 2. As has already been mentioned, the first step 202 in the preferred method is to establish a set of qualities, grouped into predetermined clusters representing specific types of corporate culture. Furthermore, on the basis of extensive research and experience, corresponding sets of questions are established in relation to each quality, the questions being designed to result in statistically valid results when applied in the measurement of corporate culture. Full details of the questions established in relation to the preferred embodiment of the invention are provided below with reference to FIGS. 3 to 23. In applying the preferred method to a particular organisation, a set of target qualities of the organisation are initially established in step 204. The target qualities are those qualities that the specific organisation being measured considers to be of greatest importance in achieving their organisational goals. The particular methods employed in the preferred embodiment to establish the target qualities are discussed later with reference to FIG. 24. However, in brief, the target qualities are typically defined by the leadership or management team 104 of the organisation, and then provided as input 106 to the system processor 102.

Once the target qualities have been defined, the next step 206 in the exemplary method is to obtain information from individuals 108, who will generally be employees and/or other individuals within, or associated with, the organisation. According to the preferred embodiment, this information is gathered by obtaining responses of the individuals to a series of questions provided as a questionnaire 110 presented by system processor 102. As previously indicated, the preferred method of presenting the questionnaire is via a web-based interface. Responses are submitted 112 by the individuals providing information to the system processor 102.

As will be appreciated, depending upon the aspect of organisational culture being measured, information may be gathered from a variety of different sources. For example, questionnaires may be completed by employees throughout the organisation, by members of specific teams within the organisation, or by persons operating at various specific levels within the organisation. Alternatively or additionally information may be gathered from clients or customers of the organisation, or other individuals familiar with or otherwise associated with, the organisation. Accordingly, the system 100 enables feedback on organisational cultures to be obtained from a variety of different perspectives, in relation to various aspects of the organisation, and it is possible to obtain 360° feedback on the organisation.

In addition to obtaining information from a variety of different individuals, the information may be related to different aspects of organisational culture. For example, information may be gathered with respect to the cultural values held by individuals, by particular teams operating within the organisation, or by the organisation as a whole. Methods for obtaining feedback on these different aspects of organisational culture, which involve altering the context in which responses to questions in the questionnaire are considered, will be discussed later with reference to FIGS. 3 to 23.

Once the responses have been submitted 112 to the system processor 102, at step 208 the responses are processed in order to assign grades to each category, or quality. In the preferred embodiment these grades are numerical values in the form of percentages, and the details of a preferred method for calculating these values will be described later in this specification.

Finally, in step 210, the system processor 102 generates one or more charts illustrating the measured organisational culture in the form of actual quality grades as compared with the target qualities established by the leadership or management team 104 in step 204. In particular, at least one chart is generated which includes graphical representations corresponding to each cluster, wherein each of said graphical representations includes specific graphical representations of the grades assigned to the corresponding quality. By presenting the culture of the organisation as measured by the system 100 in this form, it is possible to see easily the extent to which the organisation conforms with each of the five specific types of organisational culture, as well as how well aligned the organisational culture is with the key core qualities. The target qualities may be shown simultaneously on the same chart so that the differences between actual organisational culture and target organisational culture may be readily appreciated.

In the preferred embodiment the system processor 102 provides output in the form of organisational analysis charts 114 as web pages with embedded graphics served by a web server to one or more remotely located computers executing conventional web browsing software.

Each cluster, or type of corporate culture, will now be described in greater detail along with the corresponding categories, or cultural qualities, grouped within each cluster. The clusters and qualities are described with reference to FIGS. 3 to 23, which illustrate the specific questions that have been developed to measure the extent to which each quality is expressed within the organisation.

### Core Qualities

The six core qualities identified in accordance with the preferred embodiment of the invention are known as “Principled”, “Responsible”, “Purposeful”, “Composed”, “Open”, and “Humble”. The questions used to assess each of these qualities are set out in FIGS. 3 to 8 respectively. Each of these qualities will now be described in greater detail with reference, where appropriate, to the corresponding figure.

“Principled” individuals, teams and organisations hold true to their values, even in the face of adversity. Questions designed to assess this quality are set out in FIG. 3. The figure illustrates how the same set of questions may be applied to an assessment of culture as it relates to an individual, a team, or an entire organisation. The questions preferably take the form of statements, and the way in which the statements are couched affects the context (ie individual, team or organisation) to which they are applied.

For example, a respondent may be asked to indicate a degree to which they agree or disagree with a statement such as “I demonstrate my integrity” (with reference to the individual), the extent to which “the team demonstrates integrity” (with reference to the team), or the extent to which “to fit in around here, people have to demonstrate integrity” (with reference to the organisation).

As will be appreciated, each of the foregoing statements is a “positive” statement, in that a higher degree of agreement with the statement indicates that a strong, positive, performance-enhancing culture has been established with respect to this quality. A “negative” (or limiting) statement is exemplified by the statement “I stab others in the back”, wherein a high score may indicate that a negative, performance-limiting culture exists, such that change could be crucial. Conversely, a low score with respect to such a negative question is indicative of a positive culture, whereas a low score with respect to a positive question is indicative of a negative culture.

As will be seen from FIG. 3, the questions or statements include three positive, or enhancing, statements, and three negative, or limiting statements. Preferred embodiments of the present invention employ the results of extensive research and experience to establish three positive statements and three negative statements in relation to each and every cultural quality measured, in order to provide statistically significant measurements of corporate culture.

“Responsible” individuals, teams and organisations see themselves as the cause, and not the victims of outcomes. A set of enhancing and limiting statements for measuring the quality “Responsible” are illustrated in FIG. 4.

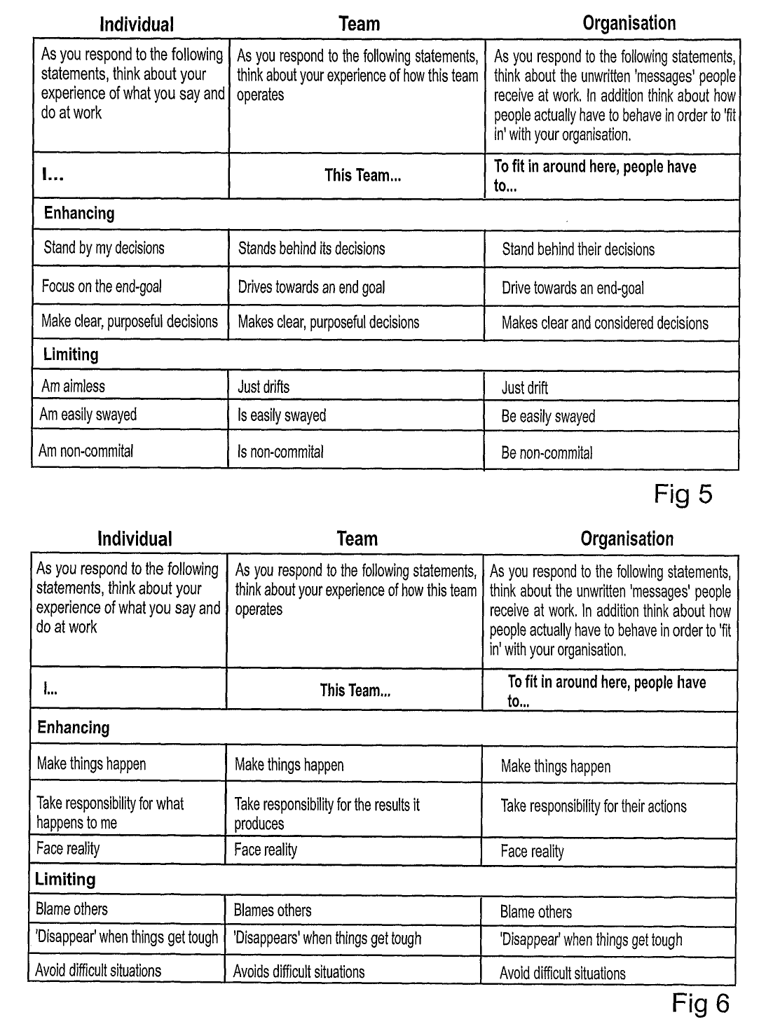

“Purposeful” individuals, teams and organisations are focused, on track, and not easily swayed or distracted. Questions or statements for assessing the “Purposeful” quality are illustrated in FIG. 5.

“Composed” individuals, teams or organisations have a strong sense of self-worth, held independently of external circumstances. Questions or statements suitable for measuring the quality “Composed” are illustrated in FIG. 6.

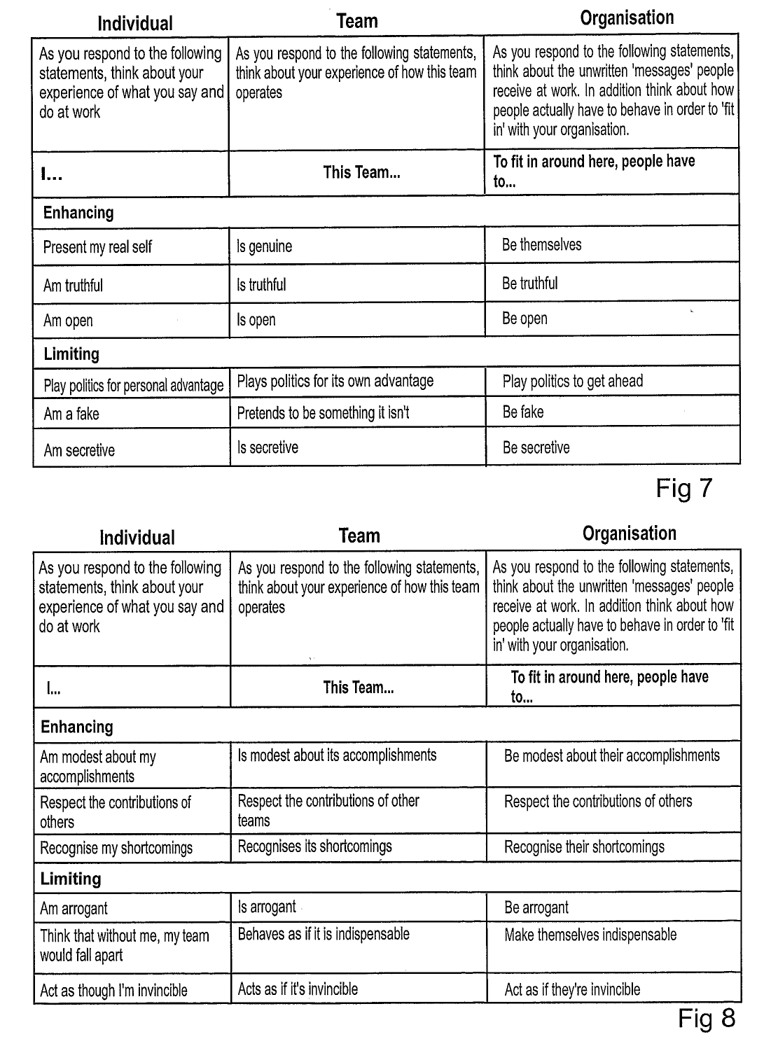

“Open” individuals, teams or organisations are congruent and transparent, may be characterised by the statement “what you see is what you get” and are trustworthy. Suitable questions for measuring the “Open” quality are illustrated in FIG. 7.

“Humble” individuals, teams and organisations have a balanced view of their own place in the world, with no need for self-aggrandisement. Suitable questions for measuring the “Humble” quality are illustrated in FIG. 8.

### External Care Qualities

The cultural type of “External Care” applies to organisations, teams and individuals who actively contribute to the quality of life around them. The three qualities making up the “External Care” cluster are known respectively as “Customer-centric”, “Responsive”, and “Big Picture”.

The performance benefits arising out of a positive culture of External Care include the facilitation of customer loyalty, allowing the organisation to win at customer retention, a capacity to build the organisation's reputation in the community, the positioning of the organisation so as to quickly pick up and respond to customer needs, the building of pride at every level, and especially within the front lines of the organisation, the enforcement of empowerment and simplicity, resulting in reduced costs to the organisation, and a reduction in rework and the cost of complaints to the organisation.

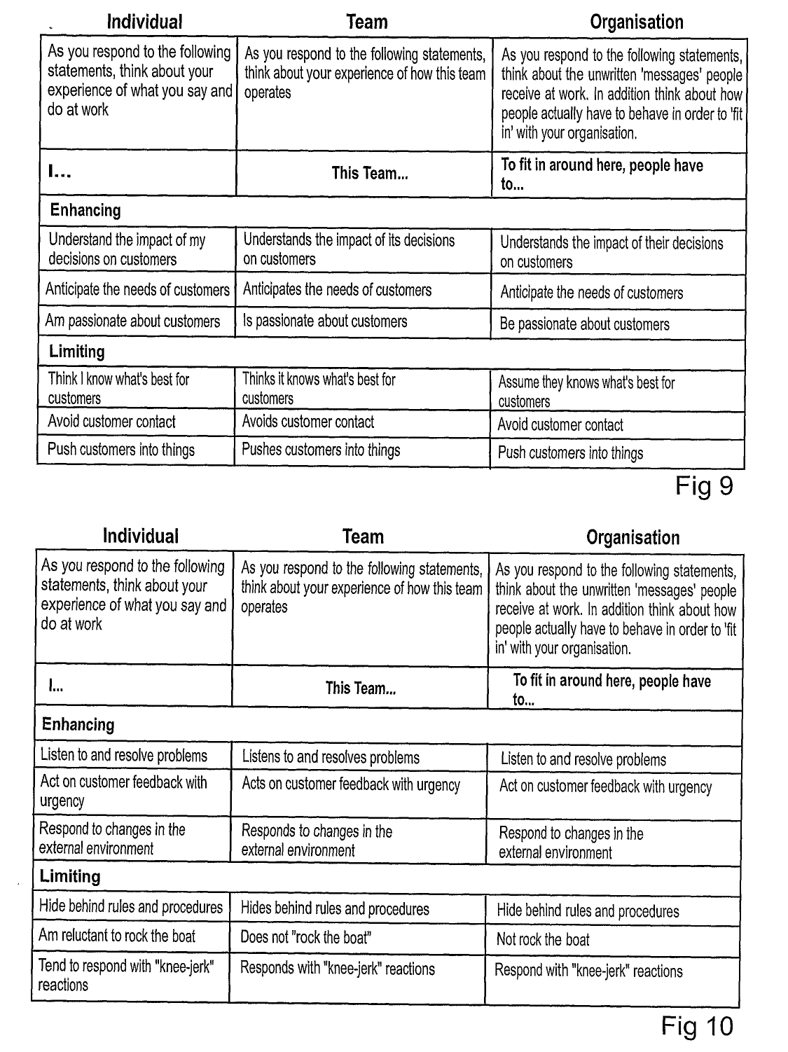

“Customer-centric” individuals, teams or organisations place the customer at the centre of decision making. Suitable questions for measuring the “Customer-centric” quality are illustrated in FIG. 9.

“Responsive” individuals, teams or organisations quickly respond to requests, feedback and changing expectations. Questions or statements suitable for measuring the “Responsive” quality are illustrated in FIG. 10.

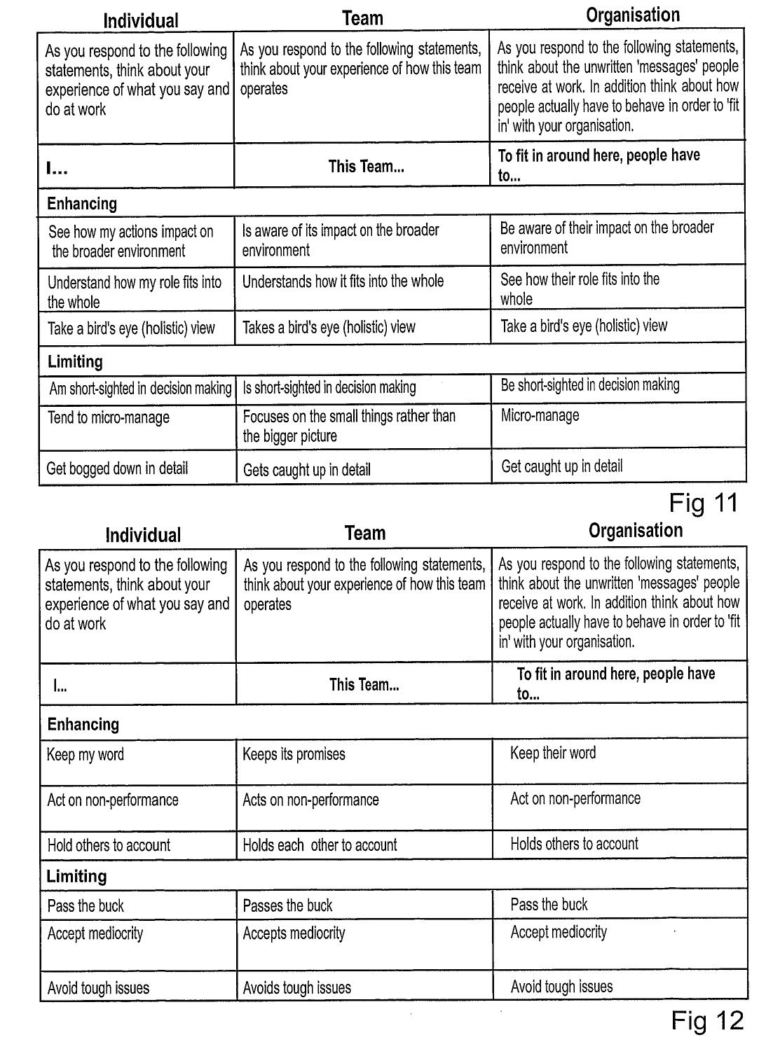

“Big Picture” individuals, teams or organisations care about their impact on the external world, and see themselves from the outside in. Questions suitable for measuring the “Big Picture” quality are illustrated in FIG. 11.

### Achievement Qualities

Organisations, teams and individuals having a positive culture of “Achievement” consistently achieve what they set out to achieve. The categories or qualities associated with the “Achievement” cultural type are “Accountable”, “Disciplined”, and “Risk Mastery”. The performance benefits to an organisation having a positive culture of achievement include an increase in the overall performance capability of the organisation, a decrease in the risk of not achieving performance targets, the ability for the organisation to stretch targets with buy-in, an increased speed of decision making and execution by the organisation, improved focus, resulting in the organisation doing fewer things very well and completing them, the organisation becoming the employer of choice for high achievers, and the organisation losing non-performing employees.

“Accountable” individuals, teams or organisations deliver on commitments and ensure the same from others. Suitable questions for measuring the “Accountable” quality are illustrated in FIG. 12.

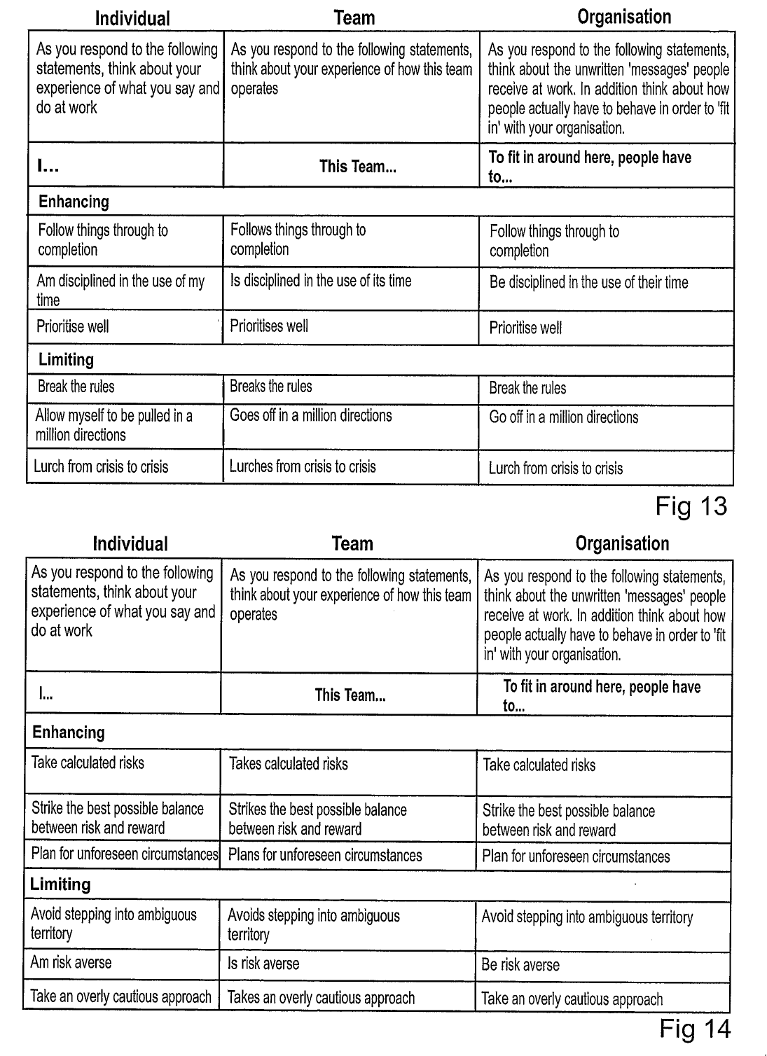

“Disciplined” individuals, teams and organisations focus efforts effectively to maximise results. Questions suitable for measuring the “Discipline” quality are illustrated in FIG. 13.

“Risk Mastery” individuals, teams or organisations manage risk actively to optimise reward. Suitable questions for measuring the “Risk Mastery” quality are illustrated in FIG. 14.

“Innovative” organisations, teams and individuals shape their own future in original ways. The performance benefits to an organisation in having a strong

“innovative” culture include the delivery of product innovation and industry leadership, the ability to retract and retain unconventional people with original ideas, the ability for the organisation to deliver speed and nimbleness, removal of the costs to the organisation associated with “not invented here”, the ability of the organisation to achieve early correction of mistakes, a reduction of escalating costs to the organisation of unsuccessful strategies, projects and/or products, and the building by the organisation of continuous improvement and reinvention.

The qualities associated with an “Innovative” culture are “Visionary”, “Initiating”, and “Coachable”.

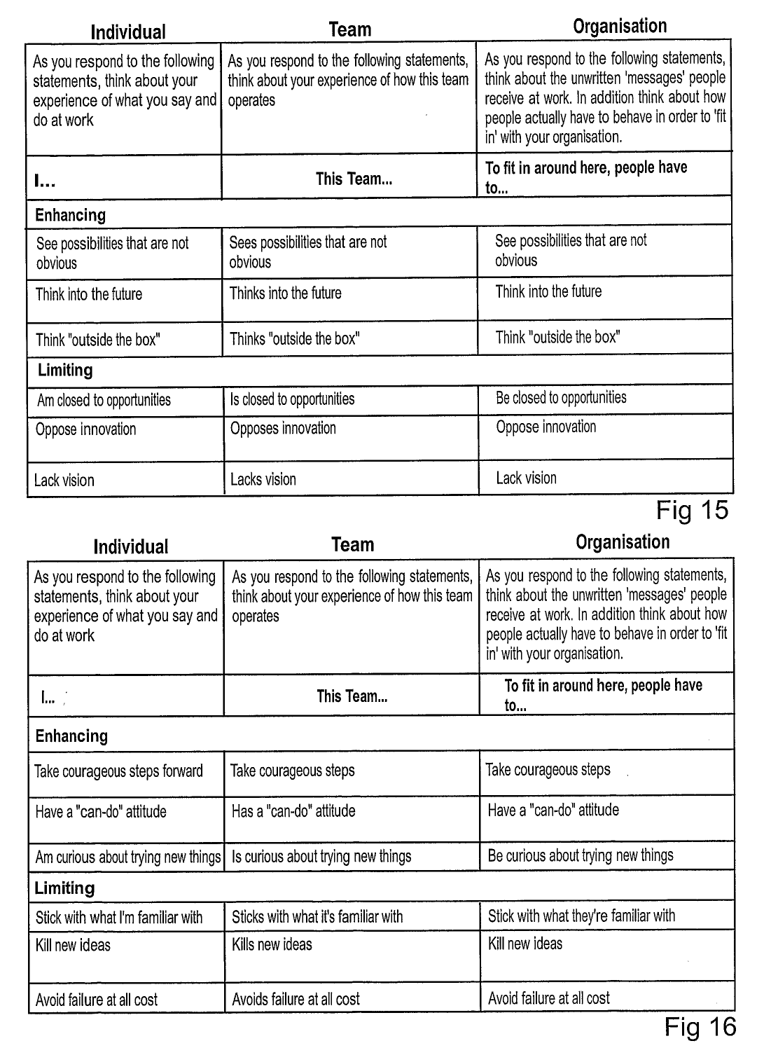

“Visionary” individuals, teams or organisations see and move towards future end states without present day evidence. Questions suitable for measuring the “Visionary” quality are illustrated in FIG. 15.

“Initiating” individuals, teams or organisations are self-starting, get things moving, and have a proactive approach to life. Questions suitable for measuring the “Initiating” quality are illustrated in FIG. 16.

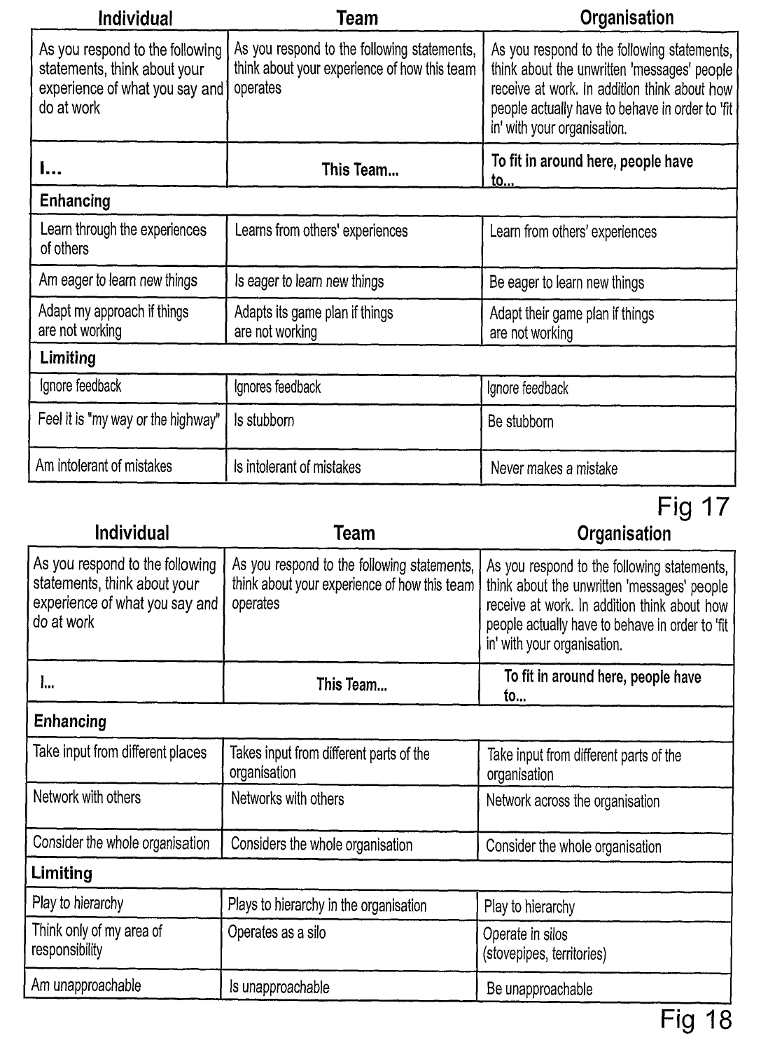

“Coachable” individuals, teams and organisations learn from others and from experience, and are hungry for improvement. Questions suitable for measuring the “Coachable” quality are illustrated in FIG. 17.

### One Team Qualities

Organisations, teams and individuals having a strong “One Team” type culture work laterally together for the good of the whole. The performance benefits to the organisation of a strong “One Team” culture are the provision to customers of the organisation of a seamless service, with effectively operating cross-business processes, the provision of cross-referrals between different sales and service teams, rapid acquisition of best practice across the group, so that organisational standards rise quickly, the reduction of duplicated effort, unless there is a strong business rationale and leaner cost base, the focusing of organisational resources where most needed, into underperforming areas, and opportunities for quick wins in the market, and the facilitation of mergers between companies, divisions or teams, and the realisation of planned synergies.

The qualities making up the “One Team” culture are “Boundaryless”, “Influencing”, and “Collaborative”.

“Boundaryless” individuals, teams and organisations think and operate across organisational boundaries. Questions suitable for measuring the “Boundaryless” quality are illustrated in FIG. 18.

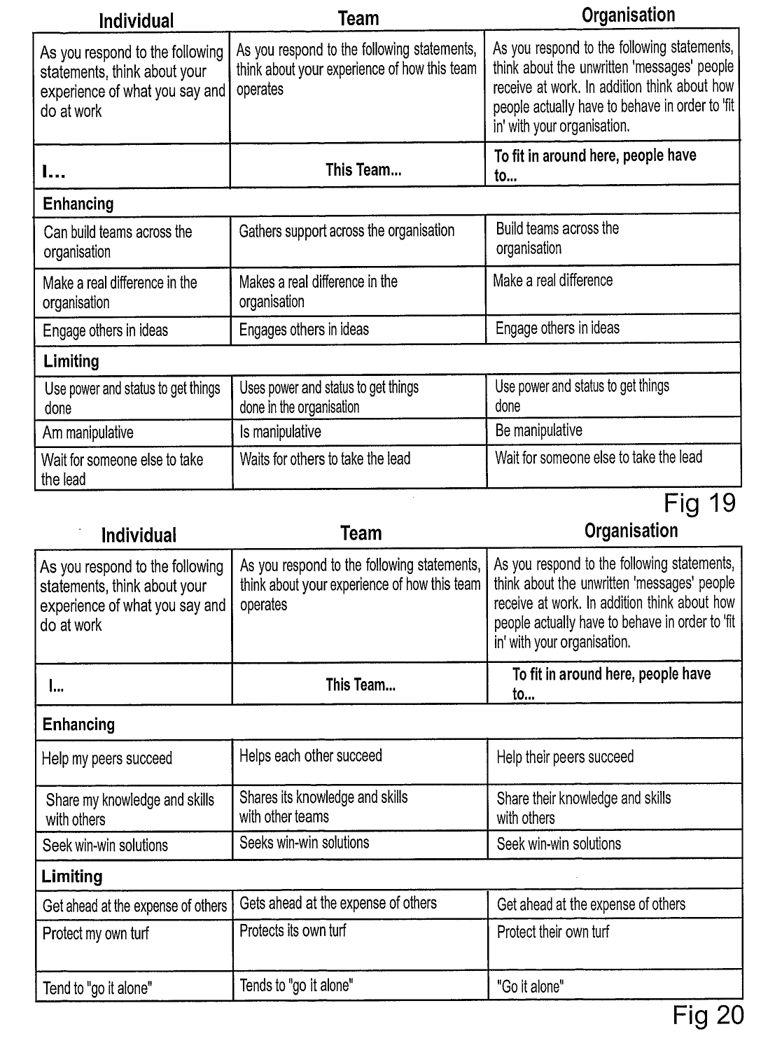

“Influencing” individuals, teams or organisations gain commitment and results from others without the need to control or coerce. Questions suitable for measuring the “Influencing” quality are illustrated in FIG. 19.

“Collaborative” individuals, teams or organisations work with others to ensure success for all. Questions suitable for measuring the “collaborative” quality are illustrated in FIG. 20.

### People First Qualities

Organisations, teams and individuals with a strong “People First” culture value, trust and care for their colleagues. The performance benefits to an organisation in having a strong “People First” culture include the building of a strong employee brand, and a reputation as an employer of choice. The enhancement of performance from individuals within the organisation, a reduction in staff turnover and recruitment fees, outstanding commitment to the organisation at the front line, which customers love, the encouragement of abundant, upward communication, with access to problems thereby avoiding surprises to the organisation, a reduction in unethical behaviour within the organisation (such as stealing and so forth), and a reduction in claims of unfair dismissal, discrimination or sexual harassment.

The qualities associated with a strong “People First” culture are “Empowering”, “Communicative” and “Empathic”.

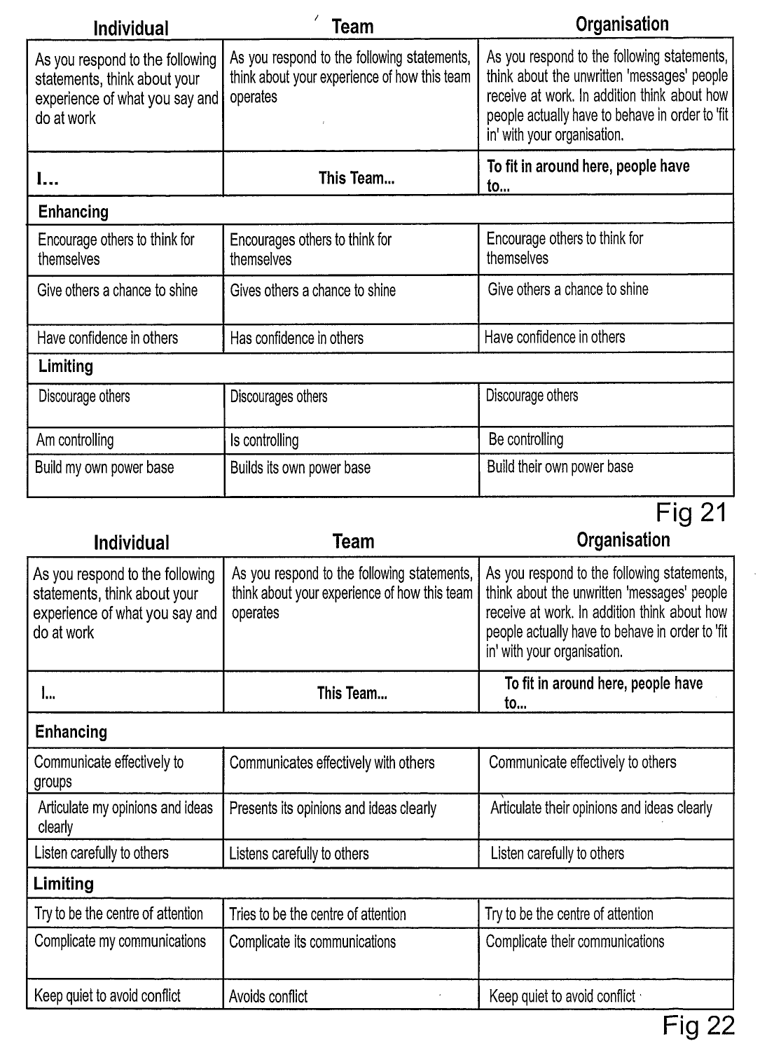

“Empowering” individuals, teams or organisations provide opportunities and support for others to grow and succeed. Questions suitable for measuring the “Empowering” quality are illustrated in FIG. 21.

“Communicative” individuals, teams or organisations express and listen to opinions in a way which produces desired outcomes. Questions suitable for measuring the “Communicative” quality are illustrated in FIG. 22.

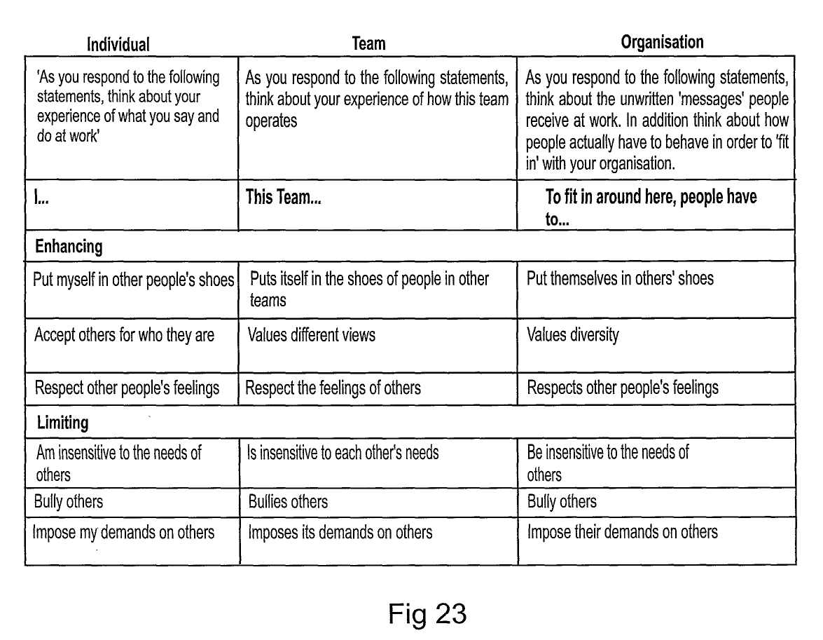

“Empathic” individuals, teams or organisations understand the feelings and circumstances of others. Questions suitable for measuring the “Empathic” quality are illustrated in FIG. 23.

### Example of Operation of the Preferred Embodiment

In the preferred embodiment of the invention, an initial step in measuring the culture of an organisation is to establish a set of target qualities (step 204 in FIG. 2). The preferred method for establishing a target culture is for organisational leaders or managers to determine a set of target qualities for the organisation, which are perceived to be supportive of achieving the organisational goals. The most preferred method for establishing the target qualities is a facilitated process performed using sets of cards, wherein each card has a named quality along with the corresponding relevant questions, as illustrated in each of FIGS. 3 to 23. The individual leaders or managers involved in establishing the target qualities work in teams to sort the cards into three categories, being most important, mid-range importance, and not important, or “already have enough”. Each of these categories is given a weighting, with most important being 70%, mid-range importance being 60% and not important being 50%. This information is then collated to form the target culture, which may be represented as a specific type of chart, known as a “target gauge”.

An exemplary target gauge 2400 is illustrated in FIG. 24. The target gauge 2400 is a chart which includes a specific graphical representation corresponding with each cluster of qualities (or culture type), wherein each cluster graphical representation includes separate graphical representations corresponding with the corresponding established target quality grades. In particular, each cluster is represented as a circle, and the corresponding grouped qualities as segments or “wedges” within the circle. Each such segment is shaded to a specific radial distance from the centre of the circle corresponding with the respective target grading. Accordingly, for example, the “Achievement” culture is represented as a circle 2402, having three wedges corresponding with the qualities “Accountable” 2404, “Disciplined” 2406″ and “Risk Mastery” 2408. In the example shown, the segments corresponding with each of these qualities are shaded out to the 70% mark indicated on a radial line of the circle 2402, demonstrating that the organisation responsible for establishing the target gauge 2400 places a high value on the “Achievement” culture in attaining their organisational goals. On the other hand, the organisation does not appear to place a high value on the “People Fist” culture, represented by circle 2410. The “Empowering” and “Empathic” qualities, represented by segments 2412 and 2416 respectively, have been assigned a rating of only 50% (not important), while the “communicative” quality, represented by segment 2414, has been assigned a 60% rating (mid-range importance).

As will be appreciated, the particular form of graphical representation provided by the target gauge 2400 enables the specific cultural aspirations of the organisation to be assessed with minimal effort, and indeed virtually at a glance.

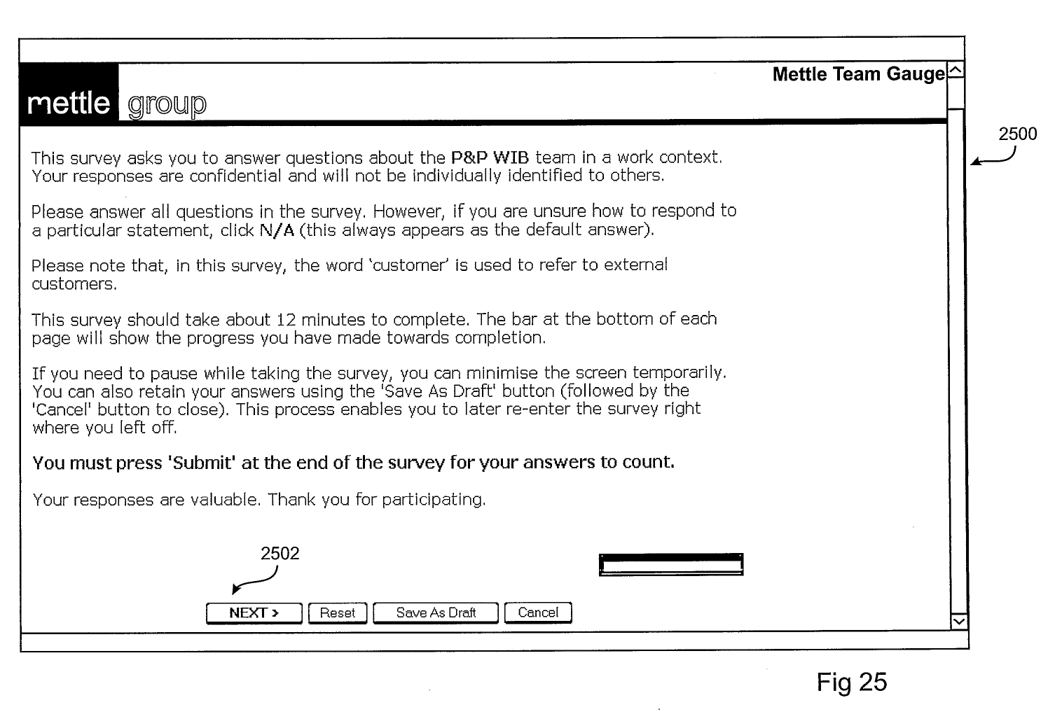

The next step in the process is to obtain information from individuals in order to assess the actual existing organisational culture, as distinct from the desired target culture (step 206 in FIG. 2). In the preferred embodiment this is achieved through a web-based interface with the system processor 102, screenshots from which are illustrated in FIGS. 25 to 27. These particular examples relate to a questionnaire conducted with respect to a team culture, however it will be readily appreciated that a similar interface, with only the context of the questions or statements being changed, for example by suitable grammatical variation, may be provided to assess individual or organisational culture.

FIG. 25 shows a web browser window displaying a questionnaire instruction page 2500. The instruction page 2500 is an initial page of the web-based questionnaire provided in the preferred embodiment of the invention. In the example shown, the instruction page informs the respondent that they are to answer the survey questions in relation to the team, and provides brief instructions for interpreting and responding to the survey questions. Once the instruction page has been read, the respondent moves to the next page, and commences responding to the survey questions, by clicking on the “next” button 2502.

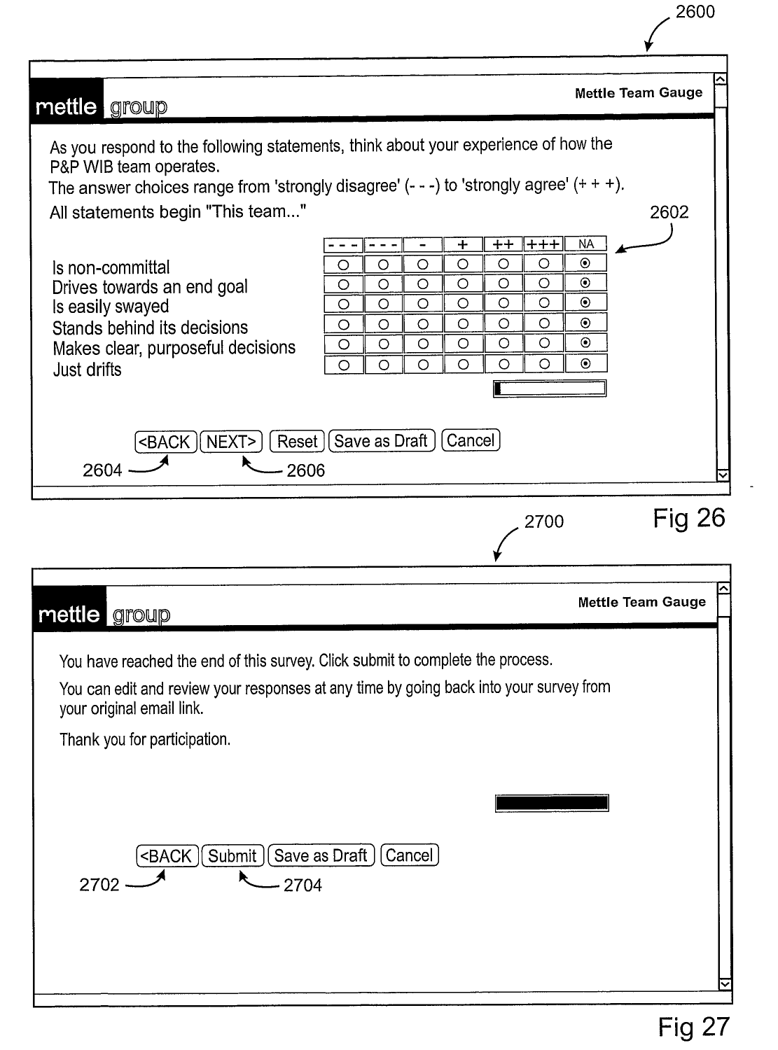

FIG. 26 shows a web browser displaying a sample question page 2600. The question page 2600 presents the six statements/questions corresponding with a single one of the 21 qualities, which in the example 2600 shown is the quality “Purposeful”. In response to each statement the respondent indicates their experience of the culture of the team by selecting from the radio buttons 2602 on a scale from “strongly disagree” to “strongly agree”. Six radio buttons are available in this range, such that the response may be considered to be provided on a scale of 1 to 6, where 1 corresponds with “strongly disagree” and 6 corresponds with “strongly agree”. An additional radio button, labelled “N/A”, is provided in case the respondent is unsure how to respond to a particular statement. At each question page, the respondent may return to the previous question by clicking on the “back” button 2604, and may move to the next question by clicking on the “next” button 2606.

Once all survey questions have been completed, the respondent is presented with a survey completion page 2700, as shown in FIG. 27. The respondent may return to the survey questions by clicking the “back” button 2702, or may submit the survey responses for processing by clicking the “submit” button 2704.

Once all individuals involved in the survey have completed the questionnaire, the results are processed. In the preferred embodiment, processing consists of accumulating responses to the survey statements that are indicative of a positive, performance-enhancing culture. In particular, a response is considered to be positive where a respondent has assigned a score of 5 or 6 (ie agree or strongly agree) in relation to a positive statement, and/or a score of 1 or 2 (ie disagree or strongly disagree) in relation to a negative statement. An overall grade for each category, or quality, is then calculated as the percentage of individuals who have responded positively to the statements relating to the corresponding cultural quality. The final results are therefore an indication of the extent to which a strong, positive, performance-enhancing culture has been established within individuals, the team, or the organisation (as appropriate) with respect to each corresponding quality or category.

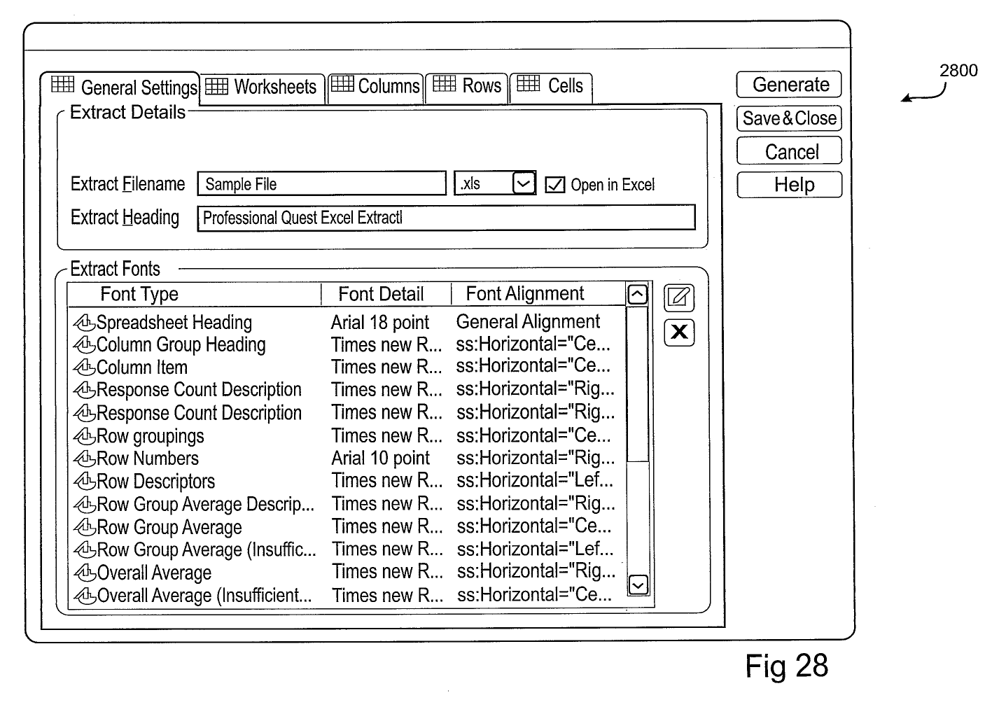

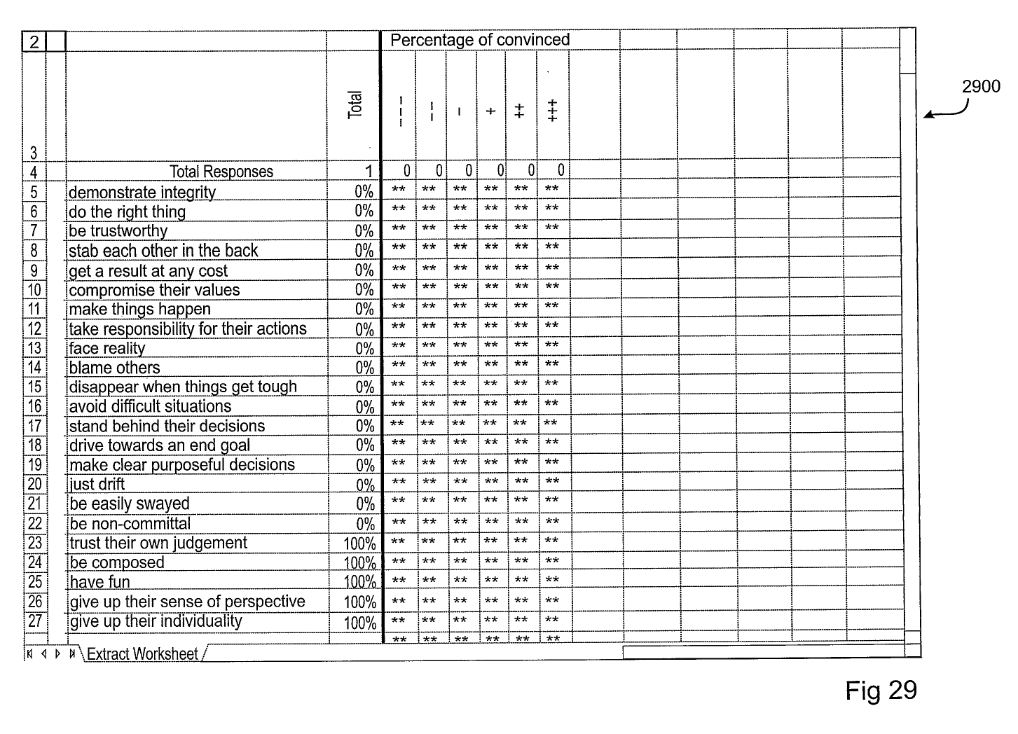

The results of the survey may be extracted and viewed in a number of ways, as illustrated in FIGS. 28 to 31. FIG. 28 shows a dialogue box 2800 which enables the raw results of the survey, in the form of responses to each individual question, to be extracted into an Excel spreadsheet 2900, as illustrated in FIG. 29.

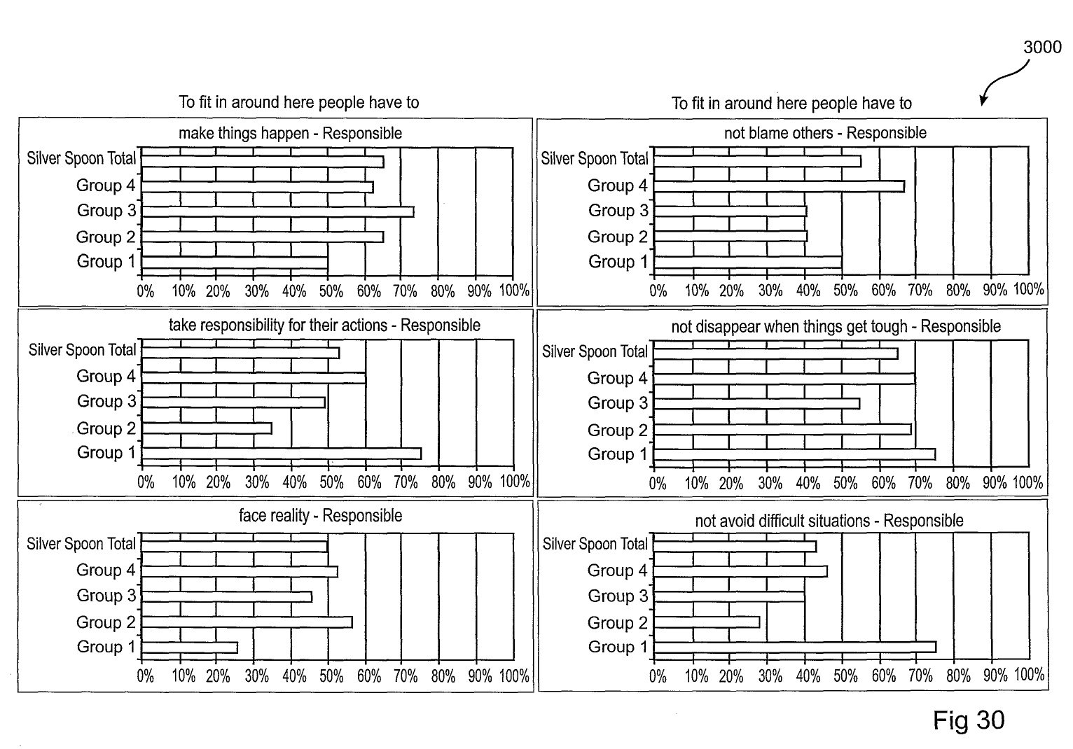

Alternatively, as illustrated in FIG. 30, in the preferred embodiment of the system it is possible to generate bar charts, eg 3000, providing overall percentages of positive responses to each individual question.

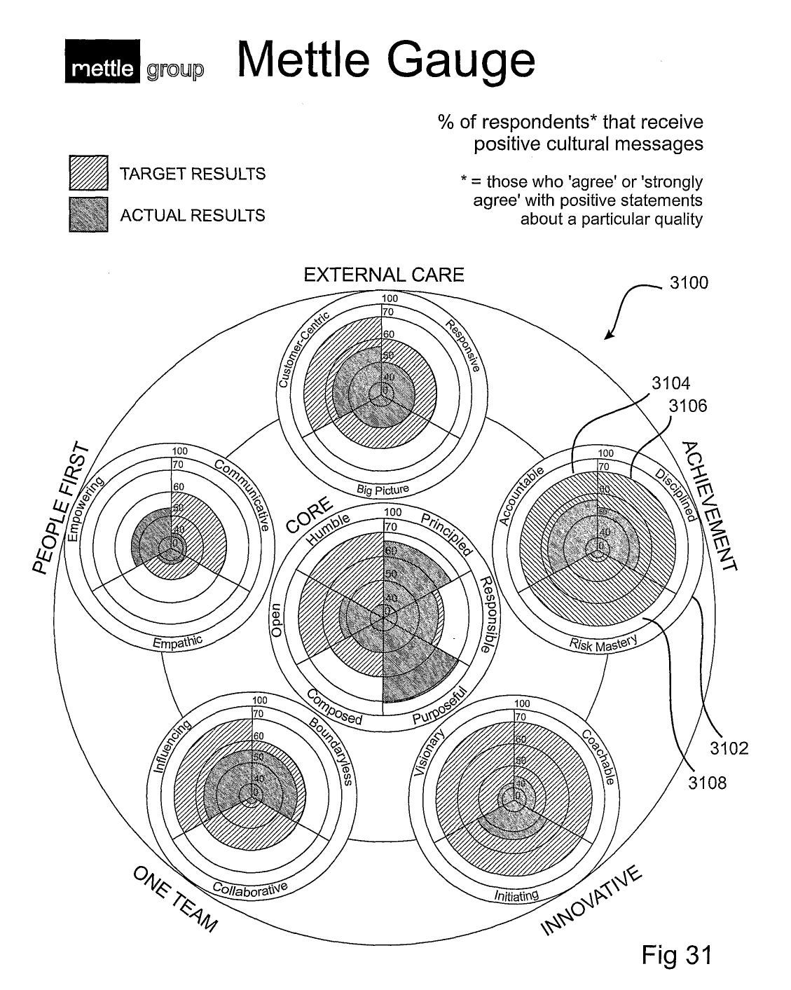

Most importantly, however, the system is able to generate a culture gauge 3100, as shown in FIG. 31, which includes both the target culture established at the beginning of the process, and the actual culture within the organisation as measured by the responses to the questionnaire.

As illustrated in the exemplary target culture gauge 2400 shown in FIG. 24, the target culture in culture gauge 3100 once again appears in the form of shaded or coloured segments or “wedges” within each circle representing an individual cluster of qualities, or type of culture. In the example culture gauge 3100, the target values are shaded within each segment using a lighter colour. The actual measured culture is represented in a similar manner, using a darker shading within each segment. The actual gradings measured for each quality are indicated by shading in the darker colour out to a radial distance within each segment or “wedge” representing the percentage of individuals who responded positively to the questions or statements relating to the corresponding quality.

By showing the target and actual culture on the same chart in this manner, it is possible for the differences between the existing culture of the organisation, and the target culture required to achieve the organisational goals, to be readily and rapidly appreciated. For example, considering the “Achievement” culture, it is easily seen from segment 3104 that the quality “Accountable” existing in the organisation fall somewhat short of the desired target. Similarly, the quality “Disciplined” falls further short of the desired target, as indicated by the shading within segment 3106, and the quality “Risk Mastery” falls furthest short of the target, as indicated by segment 3108.

The culture gauge 3100 therefore enables organisational leaders or managers rapidly to identify those qualities in relation to which work is required in order to align the actual culture within the organisation with the target culture, so as to establish a culture that is supportive of the achievement of the organisational goals.

As will be appreciated from the foregoing description, the system and method of the preferred embodiment of the invention provides a number of advantages over prior art methods. For example, it is possible to obtain feedback regarding the organisational culture, in relation to individuals, teams, or the organisation as a whole, from a variety of different individuals through a simple, online, survey mechanism. It is thereby possible to provide 360° feedback on organisational culture from an individual, team and organisational perspective, as well as obtaining such feedback from eg customers or clients.

Furthermore, a system or method embodying the invention provides a mechanism whereby the leaders or managers within an organisation can establish a target culture which is supportive of the organisational goals, thereby enabling a flexible approach to the measurement and change of organisational culture taking into account the specific needs of each individual organisation, and avoiding a “one solution fits all” approach.

The grouping of cultural categories, or qualities, into clusters relating to particular types of organisational culture facilitates a more effective appreciation of the contribution made by these cultural types to the overall culture of the organisation. The unique approach of generating a chart including graphical representations of each one of these clusters, or cultural types, facilitates a more effective appreciation of the contribution made by the different qualities and cultures to the overall culture of the organisation, and in preferred embodiments enables the gap between actual and target culture to be readily identified, so that it may be appropriately addressed.

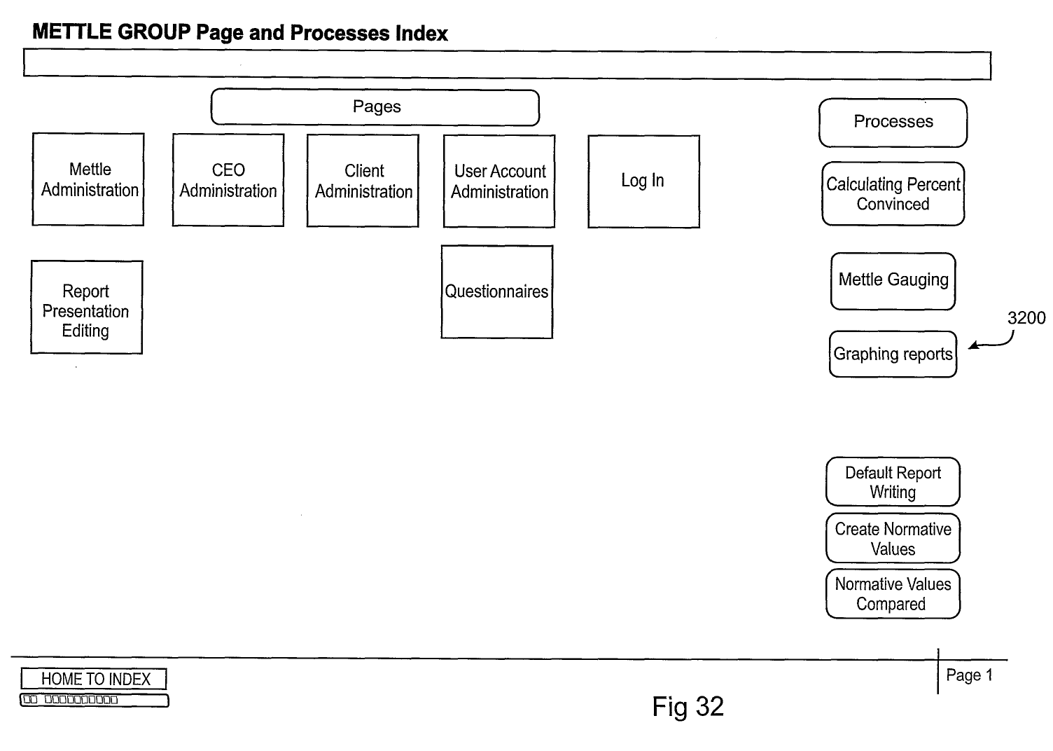

FIG. 32 illustrates an administrative interface 3200 proving a page and processes index according to the preferred embodiment of the invention. The interface 3200 enables all features of the system to be readily accessed, including various administration features, the questionnaires, processing of survey results, and extraction, graphing and display of results.

From the foregoing description, it will be readily apparent to those skilled in the art that many variations of the system and method for measuring organisational culture are possible in accordance with the invention, which is not to be limited to the particular embodiment described. For example, it will be understood that while the particular qualities, clusters and questions have been developed through extensive research and experience in order to provide a statistically valid method for measuring organisational culture, further research and experience may result in the development of new, or different, qualities, questions, and/or types of culture, which may be incorporated into methods and systems according to the invention. Therefore, while presently preferred, the six cultural types and 21 qualities, and corresponding sets of six statements or questions, should be considered to be exemplary, and not limiting of the invention.

Additionally, while the invention has been described herein with reference to a system configured primarily to measure the culture of an organisation such as a corporation, business, public- or private-sector institute or department, or the like, it will be appreciated that the invention also encompasses alternative embodiments which are configured to measure the culture of other types of organisation. For example, with suitable adaptation of the qualities, clusters, questions and so forth, based upon appropriate research and experience, the inventive method may equally be applied to different types of organisation, such as sporting bodies or teams. As will be appreciated, the culture within a sporting team affects the manner in which team members interact, the manner in which the team competes, and potentially the overall performance of the team in competition. Accordingly, embodiments of the invention directed to measuring the culture of sporting organisations are able to provide similar types of benefits as may be achieved by application of the invention to the types of organisations described herein.

Furthermore, in alternative embodiments other methods of determining a target culture, receiving information regarding actual culture from individuals, and displaying the results in the form of alternative types of charts, may be employed. Other variations, modifications and equivalents will also be apparent to persons of skill in the art, and will be understood also to fall within the scope of the present invention.

1. A method for measuring the culture of an organisation, including the steps of:
establishing a plurality of categories relating to the culture of the organisation, said categories being grouped into a plurality of clusters, wherein each cluster includes a selected one or more of said categories relating to a predetermined aspect of organisational culture;
receiving information provided by a plurality of individuals associated with the organisation regarding each of said individual's personal experience of the culture of the organisation in relation to each of said categories;
processing said received information to determine, with regard to each category, a corresponding category grade representing an extent to which the experience of said individuals is either positive or negative; and
generating a chart which includes graphical representations of each one of said clusters, each said cluster graphical representation including graphical representations of the category grades determined for the categories grouped within the corresponding cluster.

2. A method according to claim 1 which is computer implemented, and wherein at least the steps of processing received information and generating a chart are carried out using a computer.

3. A method according to claim 1 further including the step of defining a desired target culture in the form of a set of target category grades, and including in the generated chart graphical representations of the target category grades in conjunction with the determined category grades resulting from the step of processing the received information.

4. A method according to claim 3 wherein said target category grades are defined by leaders, managers or other senior members of the organisation ranking the categories in accordance with their perceived importance to an overall strategy of the organisation.

5. A method according to claim 1 wherein the step of receiving information includes providing a questionnaire to each said individual, and receiving responses of each individual to the questionnaire.

6. A method according to claim 5 wherein the questionnaire includes a series of statements, and the responses of each individual include an indication of the extent to which the individual either agrees or disagrees with each said statement.

7. A method according to claim 6 wherein the responses of each individual are provided on a numerical scale representing a corresponding level of agreement or disagreement wherein a score on said numerical scale may be associated with a strong, positive, performance-enhancing culture at one extreme of the scale, and with a negative, performance-limiting culture at another extreme of the scale.

8. A method according to claim 6 wherein each category grade represents a percentage of individuals who respond positively to statements relating to the corresponding category.

9. A method according to claim 1 wherein the step of generating a chart includes representing clusters as circles, and representing corresponding categories as segments within each circle, wherein each segment is coloured, shaded, or otherwise marked to represent the corresponding category grade.

10. A method according to claim 9 wherein each category grade is a numerical score, and each said segment is marked at a radial distance between the centre and the circumference of the corresponding cluster circle, in accordance with the numerical score.

11. A method according to claim 1 which measures the culture of the organisation in relation to a particular individual within the organisation by receiving information regarding the individual's behavioural performance within the culture of the organisation as applied to the said individual.

12. A method according to claim 1 which measures the culture of the organisation in relation to a team within the organisation by receiving information regarding the culture of the organisation as applied to the said team.

13. A method according to claim 1 which measures the culture of the organisation in relation to the organisation as a whole by receiving information regarding the culture of the organisation as applied to the whole organisation.

14. A system for measuring the culture of an organisation, the system including:
an input peripheral interface;
an output peripheral interface;
at least one storage medium containing information relating to a plurality of categories relating to organisational culture, the categories being linked within the storage medium so as to form logically a plurality of clusters wherein each cluster includes a selected one or more of said categories relating to a corresponding predetermined aspect of organisational culture; and
at least one central processing unit coupled to the at least one storage medium, the input peripheral interface, and the output peripheral interface,
wherein said at least one storage medium further includes program instructions for execution by the central processing unit, said program instructions causing the central processing unit to execute the steps of:
receiving via the input peripheral interface information provided by a plurality of individuals associated with the organisation regarding each of said individual's personal experience of the culture of the organisation in relation to each of said categories, and storing said information within the at least one storage medium;
processing said information to determine, with regard to each category, a corresponding category grade representing an extent to which the experience of said individuals is either positive or negative;
generating a chart which includes graphical representations of each one of said clusters, each said cluster graphical representation including graphical representations of the category grades determined for the categories grouped within the corresponding cluster; and
communicating via the output peripheral interface said chart to at least one user of the system.

15. A system according to claim 14 wherein the at least one storage medium further includes program instructions causing the processor to execute the step of receiving via the input peripheral interface information defining a desired target culture in the form of a set of target category grades, and for including in the generated chart graphical representations of the target category grades in conjunction with the determined category grades resulting from the processing of information provided by the plurality of individuals.

16. A system according to claim 14 wherein said program instructions cause the processor to execute, in the step of receiving information provided by the plurality of individuals, the sub-steps of presenting via the output peripheral interface a questionnaire to each of said individuals, and receiving via the input peripheral interface responses of each individual to the questionnaire.

17. A system according to claim 16 wherein the questionnaire includes a series of statements, and the responses of each individual include an indication of the extent to which the individual either agrees or disagrees with each said statement.

18. A system according to claim 17 wherein said responses of each individual are provided on a numerical scale representing a corresponding level of agreement or disagreement wherein a score on said numerical scale is associated with a strong, positive, performance-enhancing culture at one extreme of the scale, and with a negative, performance-limiting culture at another extreme of the scale.

19. A system according to claim 17 wherein said program instructions cause the processor to execute, in the step of processing received information, a sub-step of computing the category grades as a percentage of individuals who respond positively to questions relating to the corresponding category.

20. A system according to claim 14 wherein the program instructions cause the processor to execute, in the step of generating a chart, a sub-step of representing clusters as circles, and corresponding categories as segments within each circle, wherein each segment is coloured, shaded, or otherwise marked to represent the corresponding category grade.

21. A system according to claim 20 wherein the category grade is a numerical score, and each segment is marked at a radial distance between the centre and the circumference of the corresponding cluster circle, in accordance with the numerical score.

22. A system according to claim 14 which measures the culture of the organisation in relation to a particular individual, and wherein the information received via the peripheral interface relates to the individual's behavioural performance within the culture of the organisation as applied to the said individual.

23. A system according to claim 14 which measures the culture of the organisation in relation to a team within the organisation, and wherein the information received via the peripheral interface relates to the culture of the organisation as applied to the said team.

24. A system according to claim 14 which measures the culture of the organisation in relation to the organisation as a whole, and wherein the information received via the input peripheral interface relates to the culture of the organisation as applied to the whole organisation.

25. A system for measuring the culture of an organisation, wherein a plurality of categories relating to the culture of the organisation is established, the categories being grouped into a plurality of clusters wherein each cluster includes a selected one or more of said categories relating to a corresponding predetermined aspect of organisational culture, the system including:
input means for receiving information provided by a plurality of individuals associated with the organisation regarding each said individual's personal experience of the culture of the organisation in relation to each of said categories;
a processor for processing said received information to determine, with regard to each category, a corresponding category grade representing an extent to which the experience of said individuals is either positive or negative; and
output means for generating a chart which includes graphical representations of each one of said clusters, each said cluster graphical representation including graphical representations of the category grades determined for the categories grouped within the corresponding cluster.

26. A system according to claim 25 wherein the output means is further adapted to provide a questionnaire to each said individual, and the information received via the input means includes responses provided by said plurality of individuals to the questionnaire.

27. A system according to claim 26 wherein the questionnaire includes a series of statements, and the responses of each said individual include a indication of the extent to which the individual either agrees or disagrees with each said statement.

28. A system according to claim 25 wherein the output means is further adapted to generate said chart including clusters represented as circles, and corresponding categories represented as segments within each circle, and wherein each segment is coloured, shaded, or otherwise marked to represent the corresponding category grade.

29. A system according to claim 28 wherein the category grade is a numerical score, and the output means is adapted to generate the chart such that each segment is marked at a radial distance between the centre and the circumference of the corresponding cluster circle in accordance with the numerical score.

30. A system according to claim 25 which measures the culture of the organisation in relation to a particular individual within the organisation by receiving information regarding the individual's behavioural performance within the culture of the organisation as applied to the said individual.

31. A system according to claim 25 which measures the culture of the organisation in relation to a team within the organisation by receiving information regarding the culture of the organisation as applied to the said team.

32. A method according to claim 25 which measures the culture of the organisation in relation to the organisation as a whole by receiving information regarding the culture of the organisation as applied to the whole organisation.

33. A tangible computer-readable medium having embodied thereon computer-executable instruction code which, when executed when executed, causes a computer to execute a method for measuring the culture of an organisation, wherein a plurality of categories relating to the culture of the organisation is established, said categories being grouped into a plurality of clusters, wherein each cluster includes a selected one or more of said categories relating to a corresponding predetermined aspect of organisational culture, the method including the steps of:
receiving information provided by a plurality of individuals associated with the organisation regarding each said individual's personal experience of the culture of the organisation in relation to each of said category;
processing said received information to determine, with regard to each category, a corresponding category grade representing an extent to which the experience of said individuals is either positive or negative; and
generating a chart which includes graphical representations of each one of said clusters, each said cluster graphical representation including graphical representations of the category grades determined for the categories grouped within the corresponding cluster.
